(19) United States
(12) Patent Application Publication
(10) Pub. No.: US 2012/0162692 A1
(43) Pub. Date: Jun. 28, 2012

(54) IMAGE FORMING APPARATUS

(75) Inventors: Yuuki AIDA, Ibaraki-ken (JP); Daisuke ORIKASA, Ibaraki-ken (JP); Tsutomu KUROSE, Ibaraki-ken (JP); Kouichi NOBUSHIMA, Ibaraki-ken (JP)

(73) Assignee: RISO KAGAKU CORPORATION, Tokyo (JP)

(21) Appl. No.: 13/337,579

(22) Filed: Dec. 27, 2011

(30) Foreign Application Priority Data
Dec. 28, 2010 (JP) P2010-293876

(51) Int. Cl. G06K 15/02

(52) U.S. Cl. 358/1.14; 358/1.15

(57) ABSTRACT

An image forming machine transitions into a sleep mode at a preset time of day, and keeps the sleep mode for a prescribed interval. The image forming machine includes an I/O interface, a printer, a memory, and a controller. The interface inputs a print job. The printer executes a printing of the print job. The memory stores therein an entirety or part of the print job overlapping the interval of the sleep mode, as a hold job. The controller works to have the memory store the hold job therein, and to have the printer operate after an end of the interval of the sleep mode to execute a printing of the hold job stored in the memory

### BACKGROUND OF THE INVENTION

1. Technical Field

The present invention relates to an image forming apparatus, and particular to an image forming apparatus adapted to make a transition to a sleep mode at a preset time of day, and keep the sleep mode for a prescribed interval of time.

2. Background Arts

There are printers connected to external terminals such as personal computers constituting LANs (local area networks) in offices or homes. Typical LANs are each adapted to use a single printer as a common to external terminals, permitting effective use of the printer. Printers have their printing functions. Printers recently used may be a composite type provided with an additional function such as a scanner function or facsimile function.

Most printers installed in offices or homes are employed as inkjet printers. Inkjet printers can make high-speed prints at low costs, including massive monochrome or color prints.

Assuming a print job transmitted from any one of external terminals in a LAN, when the print job is received at a printer, the printer operates to execute a printing in accordance with the received print job. For execution of the printing, the printer must be set in a ready mode with necessary power supplied to most parts thereof including a controller, a panel, and an ink circulation system.

Printers set in a ready mode tend to consume increased power. There is a technique disclosed in Japanese Patent Application Laid-Open Publication No. 2008-278104, in which a printer is shifted to a sleep mode after a prescribed time elapsed with no print jobs received. The sleep mode is a state of waiting jobs in an energy saving manner. In this mode, the printer is kept in a main-on state free from power distribution to most printer parts including a controller. This is a non-printing state of the printer in which power consumption of the printer can be decreased. In a LAN including a printer and external terminals, it is unknown when and from which terminal the printer receives a print job. Therefore, when given a sleep mode function, the printer is effectively operable to reduce power consumption.

### SUMMARY OF THE INVENTION

However, there was no substantial consideration taken for printers incorporated in a LAN in the following points. In a LAN, electric energy consumed in the entirety tends to increase as the number of printers or external terminals incorporated therein is increased. In this regard, trials were made to restrict use of printers to decrease the amount of energy that might have been consumed by the use of printers. Some trials were made to restrict use of printers in hours of day when the electricity rate was high. Some trials were made to restrict use of printers during breaks in an office, such as a lunch break, in compliance with a rule for improvement of environment at the office. It is effective for realization of such trials to provide printers with a scheduling function. This function includes a transition into a sleep mode to be kept for a prescribed interval (of time) from a preset time of day. The sleep mode is a control mode of power distribution to be selected when a time of day preset by the user is arrived at. The state of power distribution may have been a ready mode until the arrival. In this case, the ready mode is followed by a forced transition into a sleep mode, and this sleep mode is kept for a prescribed interval. The state of power distribution may have been a sleep mode until the arrival. In this case, the sleep mode is kept as it is, to continue for a prescribed interval. Printers in the past had a state of power distribution kept free from operation for or reception of any print job for a prescribed interval, and followed by a mere transition into a sleep mode. Unlike them, the above-noted scheduling undergoes a forced transition into a sleep mode to be kept for a prescribed interval from a preset time of day.

However, there may be a print job received or being received immediately before the preset time of day, involving massive pages amounting to e.g. thousands or tens of thousands. There may be a print job having a massive number of pages in the midway of printing when the preset time of day has come. In such cases, it is prohibited to enter the sleep mode at the very time the user has intended. As a result, the state of power distribution goes far beyond the preset time of day to transition into the sleep mode. Power consumption is thus increased between the preset time of day and the transition into the sleep mode.

The present invention has been invented in view of such issues. It therefore is an object of the present invention to provide an image forming apparatus allowing for an ensured presence of a sleep mode kept for a prescribed interval after a preset time of day, with reduced power consumption.

To achieve the object, according to an aspect of the present invention, there is an image forming apparatus adapted to transition into a sleep mode at a preset time of day and keep the sleep mode for a prescribed interval. The image forming apparatus comprises an input interface, a printer, a memory, and a controller. The input interface is configured to input a print job. The printer is configured to execute a printing of the print job. The memory is configured to store therein an entirety or part of the print job overlapping the interval of the sleep mode, as a hold job. The controller is configured to have the memory store the hold job therein, and have the printer operate after an end of the interval of the sleep mode to execute a printing of the hold job stored in the memory.

### BRIEF DESCRIPTION OF THE DRAWINGS

FIG. 1 is a block diagram of an image forming machine as an image forming apparatus constituting an image processing system according to a first embodiment of the present invention

FIG. 2 is a flowchart describing a control method for a transition into a sleep mode in a scheduled run of the image forming machine according to the first embodiment

FIG. 3 is a flowchart describing a control method for a return from the sleep mode in the scheduled run of the image forming machine according to the first embodiment

FIGS. 4A, 4B, and 4C are tables listing contents of information that specific print jobs and hold jobs have upon transition into a sleep mode in the image forming machine according to the first embodiment.

FIGS. 5A, 5B, and 5C are time charts including sleep modes in a scheduled run of the image forming machine according to the first embodiment

FIGS. 6A, 6B, and 6C are tables listing contents of information that specific print jobs and hold jobs have upon transition into a sleep mode in the image forming machine according to the first embodiment

FIG. 7 is a flowchart describing a control method for a transition into a sleep mode in a scheduled run of an image forming machine according to a second embodiment of the present invention.

FIG. 8 is a flowchart describing a control method for a return from the sleep mode in the scheduled run of the image forming machine according to the second embodiment

FIG. 9 is a flowchart describing a control method for a return from a sleep mode in a scheduled run of an image forming machine according to a third embodiment of the present invention.

### DESCRIPTION OF THE EMBODIMENTS

There will be described embodiments of the present invention with reference to the drawings. In the drawings, the same or similar parts are designated at the same or similar reference signs. It is noted that drawings show what is typical, not real.

The embodiments to be described are illustrative to show specific apparatuses or methods implementing a technical concept according to this invention. The technical concept of this invention does not restrict arrangements of components or the like to what is described below The technical concept of this invention can be modified in various manners, within the scope of claims.

### First Embodiment

The first embodiment of the present invention is described an example of the present invention applied to an image forming machine as an image forming apparatus including a complex type inkjet printer that has an ink circulation system. The image forming machine constitutes part of an image processing system connected to external terminals through a LAN. It is noted that the present invention is applicable not simply to an image forming apparatus including a complex type inkjet printer, but also to image forming apparatuses including various printers, such as a non-complex type inkjet printer, a laser printer, and a thermal transfer printer.

[Configuration of Image Processing System]

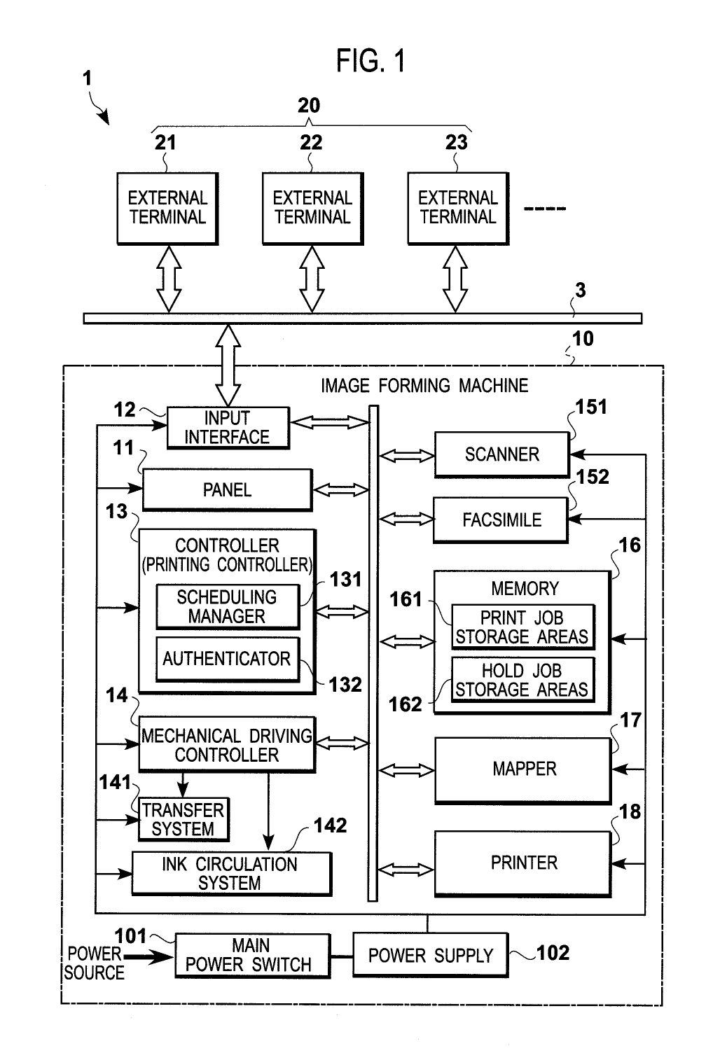

FIG. 1 shows an image processing system 1 according to the first embodiment The image processing system 1 includes an image forming machine 10, and external terminals 20 (21, 22, 23 . . . ). The image forming machine 10 is connected to the external terminals 20 through a communication network 3. Here, the image forming machine 10 is assumed to be a complex type color inkjet printer that has an ink circulation system. Among the external terminals 20, individual terminals 21, 22, 23, . . . may be composed of a desk top type personal computer, a note type personal computer, a PDA (personal digital assistant), etc. The terminals 21, 22, 23, . . . each have functions of preparing sets of data on image frames, holding or storing frame data, and transmitting a series of frame data as a print job to the image forming machine 10.

The communication network 3 is a network of data transfer routes interconnecting the image forming machine 10 with external terminals 20. The interconnection may be an intra-office, between offices, between an office and homes, between an office and outside places, etc. The communication network 3 may include a wired LAN, a wireless LAN, the Internet, a telephone line, an optical cable, a USB (universal serial bus) cable, or a specific cable such as an IEEE 1394 compliant with the SCSI (small computer system interface) standard, as a data transfer route therein. The image forming machine 10 is shared for use among the external terminals 21, 22, 23, . . . .

This example shows a single image forming machine 10. It however is noted that the number of image forming machines 10 shared among external terminals 21, . . . is not limited, and may be two or more.

[Configuration of Image Forming Machine]

According to the first embodiment, the image forming machine 10 has a scheduling function of scheduling a run to transition into a sleep mode at a preset time of day, and keep the sleep mode for a prescribed interval (of time). The scheduling function is a function to make an automatic and forced transition into a sleep mode for restricting use of the image forming machine 10 to reduce power consumption. The restriction may be made to restrict using the image forming machine 10 during e.g. hours of day when the electricity rate is high. The restriction may be made to restrict using the image forming machine 10 during e.g. breaks in an office, such as a lunch break, in compliance with a rule for improvement of environment at the office.

Here, the preset time of day means a time of day the user has intentionally set up in advance as a time to enter a sleep mode. For instance, the user may want to restrict having the image forming machine 10 execute a printing process after a time of 12:00 in a lunch break. In this case, the time of 12:00 corresponds to the time of day to be preset. The transition into a sleep mode includes at least a transition into the sleep mode from a printable ready mode, and a transition into the sleep mode from another sleep mode (i.e. a continuation of this sleep mode). For any sleep mode, the prescribed interval means a certain interval (of time) the user has intentionally set up in advance. This is an interval between a time-of-day set to enter a sleep mode (as a timing to transition into the sleep mode) and a time-of-day set to end the sleep mode (as a timing to return from the sleep mode). For instance, the user may have set one hour as an interval from a start of a lunch break. This corresponds to the interval between 12:00 and 13:00 in the above case.

As shown in FIG. 1, the image forming machine 10 includes a main power switch 101, a power supply 102, a panel 11, and an I/O port (as an I/O communication processor) 12. Moreover, the image forming machine 10 includes a controller (as a printing controller) 13, and a mechanical driving controller 14 for driving a transfer system 141 and an ink circulation system 142. Further, the image forming machine 10 includes a memory 16, a mapper 17, and a printer (as a printing engine) 18. According to the first embodiment, the image forming machine 10 is provided as a complex type inkjet printer including a scanner 151 and a facsimile 152.

The main power switch 101 of the image forming machine 10 is connected to a commercial power source. The main power switch 101 serves as a switch for powering on and off an entirety of the image forming machine 10. More specifically, the main power switch 101 is used as a switch for causing the image forming machine 10 to transition from a main-off state into a standby mode, and to transition from a main-on state (e.g. one of the standby mode, a sleep mode, and a ready mode) into the main-off state. The power supply 102 regulates power supplied through the main power switch 101. Regulated power is supplied from the power supply 102 to individual machine parts including the panel 11, the controller 13, the mechanical driving controller 14, and the printer 18.

The panel 11 serves as an operation controller for accepting user's direct instructions to operate the image forming machine 10. For instance, the panel 11 is manually operable to instruct a printing operation for a printing or copying, or use the scanner 151 or part of the facsimile 152 for reading frames of images. The panel 11 has a non-depicted display for displaying contents of services or such, and functional elements such as button switches or key switches associated with a manually operable touch panel. According to the first embodiment, the image forming machine 10 can accept user's operations to the panel 11, to receive necessary information for scheduling a run. Received information includes at least a time of day to be set for transition into a sleep mode, and an interval to be set for continuation of the sleep mode. There is a user authorized to manage the image forming machine 10. The authorized user can use an external terminal 20 to provide the image forming machine 10 with necessary information for setting a scheduled run through the communication network 3. This setting of information requires an authentication using e.g. a manager ID and a password.

In the first embodiment, the main-off state is a state in which the main power switch 101 is turned off, and no power is supplied to individual machine parts. The standby mode involves a state in which the main power switch 101 is operated from an off position to an on position supplying power simply to the power supply 102 and the panel 11. It is noted that the display of the panel 11 is kept off in the standby mode.

The sleep mode involves a non-printing state (a state in which no printing process is executed) providing that the main power switch 101 and a non-depicted power key switch are set to on states (powered states). The sleep mode involves a state of waiting jobs in an energy saving manner (as a power reducing state). The state of power distribution of the image forming machine 10 automatically transitions into the job waiting state, such as when a preset interval of time has elapsed with no operations accepted or with no print jobs received. The above-noted sleep mode is similar to a normal sleep mode, in that the state of power distribution transitions into a state of waiting jobs in an energy saving manner. However, that sleep mode is different from this sleep mode, in that the former is a forced sleep mode in a scheduled run and has a time of day preset to start a transition and a time of day preset to return therefrom.

There is a low power mode that involves a state in which the display of the panel 11 is in an off state (for instance, in the case of a liquid crystal display, the backlight is turned off), and operations are prohibited at machine parts which can consume large power. Those machine parts include the mechanical driving controller 14, the transfer system 141, the ink circulation system 142, and the printer 18. The ready mode involves a state in which most parts of the image forming machine 10 including the controller 13 are supplied with power, and are ready to execute a printing operation in accordance with a print job.

At the image forming machine 10, the I/O port 12 is connected to the communication network 3, and is connected to external terminals 20 through the communication network 3. The I/O port 12 receives information (electronic data) transmitted from any external terminal 20. Received information from an external terminal as a user may include a print job combined with a user ID and a user password required for authentication of the user. The print job may contain a series of frame data to be printed on sheets of paper or the like. The I/O port 12 may have slots for insertion of a mobile memory, to take in electronic data stored in the mobile memory. Electronic data stored in the mobile memory may be frame data prepared at an external terminal 20. The mobile memory may be a USB memory, an IC (integrated circuit) card, an SD (secure digital) card, etc. According to the first embodiment, the I/O port 12 of the image forming machine 10 is operable not simply to receive information, but also to transmit information. The I/O port 12 can transmit information on a state of printing or such to an external terminal 20 that has e.g. logged in.

The controller 13 is connected to most machine parts, and governs their control. The machine parts to be governed include the panel 11, the I/O port 12, the mechanical driving controller 14, the scanner 151, the facsimile 152, the memory 16, the mapper 17, and the printer 18. According to the first embodiment, the controller 13 has a scheduling manager 131. The scheduling manager 131 manages scheduling a run of the image forming machine 10. In particular, the scheduling manager 131 is responsible for the following managements. Once a time of day for entering a sleep mode is set by the user through the panel 11 or in any possible manner else, the scheduling manager 131 follows a resultant schedule. In due course, under a management of the scheduling manager 131, the state of power disttibution transitions into the sleep mode. Once a time of day for returning from the sleep mode is set, the scheduling manager 131 follows a resultant schedule for a management to return from the sleep mode after lapse of a prescribed interval. The scheduling manager 131 may be configured as hardware using a dedicated circuit The scheduling manager 131 may be configured as a combination of a CPU (central processing unit) in the controller 13 and a program stored in a memory to read for execution at the CPU.

Further, the controller 13 has an authenticator 132. The authenticator 132 serves to authenticate a user ID and a user password input from any external terminal 20 through the I/O port 12. The authenticator 132 restricts unauthenticated external terminals from using the image forming machine 10. The authenticator 132 is configured as a combination of a CPU in the controller 13 and a software application running on the CPU. The application is stored in a ROM (read only memory) or a database of the controller 13. The authenticator 132 may be configured as a combination of a dedicated circuit (as hardware) using a CPU, an application running on the CPU, and a memory for storing the application.

The controller 13 controls operations of the mechanical driving controller 14, writing data to the memory 16, reading data from the memory 16, operations of the mapper 17, operations of the printer 18, and the like. The mechanical driving controller 14 is connected to the transfer system 141 and the ink circulation system 142, and controls their operations.

The transfer system 141 includes transfer rollers operable with drive motors, a suction unit for suctioning a recording medium such as a sheet of paper, etc., which are driven under control of the mechanical driving controller 14. The ink circulation system 142 has four ink circulation routes for independent circulation of black, cyan, magenta, and yellow inks At each ink circulation mute, ink is supplemented from an inkbottle, and supplied to an array of print heads. Surplus ink unused for printing is collected from the print head array. Ink is thus circulated along each ink circulation route. Each ink circulation route includes a circulation pump, a pressure controller, a heater, and a cooler installed thereon. The circulation pump pumps ink to circulate. The pressure controller controls an ink pressure in the circulation mute. The heater and the cooler are cooperative to control an ink temperature.

The memory 16 used may be a hard disc having a large storage capacity. According to the first embodiment, the memory 16 includes print job storage areas 161 and hold job storage areas 162. The print job storage areas 161 serve to store therein print jobs received through the I/O port 12. The hold job storage areas 162 serve to store therein those print jobs or parts thereof identified as hold jobs upon a transition into a sleep mode. The hold jobs are prohibited from being printed during a prescribed interval of the sleep mode. The memory 16 may be composed of two or more memory devices (e.g. hard discs) having print job storage areas 161 and hold job storage areas 162 allotted thereto, respectively. The memory 16 may be a single memory device having print job storage areas 161 and hold job storage areas 162 all allotted thereto.

It is noted that the controller 13 can always categorize (print data of) print jobs stored in print job storage areas 161 into any one of five kinds. That is, they can be categorized into one of a print job “being received” without printing, a print job “being received” while “being printed”, a print job put in a waiting state after reception, a print job “being printed” after reception, and a print job completed with all pages printed.

The mapper 17 is operable under control of the controller 13 to map a print job into a series of print data formatted to be printable at the printer 18. The print job mapped may be a print job read from a print job storage area 161 of the memory 16, or ahold job read from a hold job storage area 161 of the memory 16. For instance, the mapper 17 may operate on frame data of a print job or a hold job, to generate print data as maps of bits pixel-wise associated with pixel values.

The printer 18 is operable under control of the controller 13 to discharge ink from print heads, making a print on a recording medium in accordance with print data generated at the mapper 17.

The scanner 151 has a function of taking frames of images on sheets of paper or such, as frame data to be stored in a database of the controller 13 or in the memory 16. The facsimile 152 has a function of using the communication network 3 or a telephone line to transmit frame data taken by the scanner 151, and a function of receiving frame data from an external facsimile.

The image forming machine 10 according to the first embodiment has increased power consumption, as machine 1 parts associated with mechanical operations work. Those machine parts include the mechanical driving controller 14, the transfer system 141, the ink circulation system 142, the printer 18, and the scanner 151. Those machine parts can be suspended from operations to achieve a significant decrease in power consumption during a forced sleep mode in a scheduled run, as well as during a normal sleep mode.

[Control Methods of Image Forming Machine]

(1) Method of Transitioning into a Sleep Mode

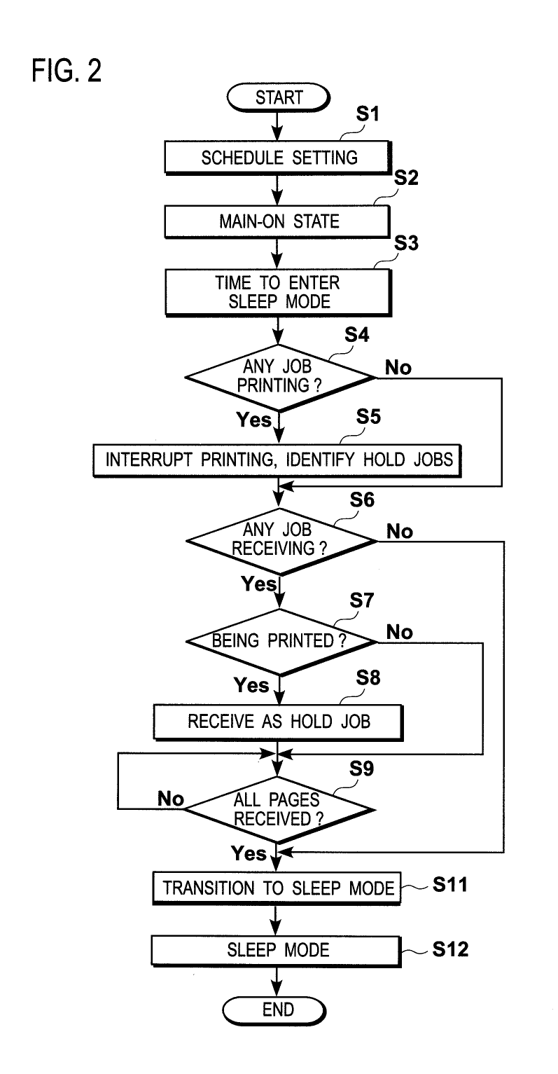

FIG. 2 shows a method of transitioning into a sleep mode in a scheduled run of the image forming machine 10 according to the first embodiment.

First, at a step S1, for a course of run of the image forming machine 10, a schedule is set by a managing person (as a user) authorized to manage scheduling the run of the image forming machine 10. As an example, the run is scheduled over hours of a day in an office between 8:00 am. when work starts and 6:00 p.m. when work ends. The scheduled run includes an interval of time between 12:00 am. and 1:00 p.m., and another interval of time between 3:00 p.m. and 3:30 p.m. The two intervals are set as prescribed intervals for (i.e. durations of) two forced sleep modes, respectively. The sleep modes are introduced to prohibit printing during the intervals, with an intention to save power along with a rule for improvement of environment. The managing person is authorized to adjust the scheduled run, subject to an authentication of the person. The authentication follows an authentication procedure instructed from the authenticator 130 of the controller 13. The authentication procedure ensures an authentication based on a user ID and a user password, between the managing person or an external terminal 20 and the image forming machine 10. The scheduled run may be adjusted by direct operations to operational elements on the panel 11 of the image forming machine 10. Or instead, the adjustment may be made by indirect operations from an external terminal 20 to the image forming machine 10 through the communication network 3.

At a step S2, the image forming machine 10 is set in a main-on state. That is, the image forming machine 10 is working in any one of a standby mode, a low power mode, and a ready mode. If a print job is received from any external terminal 20, the image forming machine 10 keeps, or transitions into, the ready mode to execute a printing of the print job.

It is noted that, in the scheduled run, if any print job is received to its end while another print job is in the way of printing, the controller 13 puts that print job in a waiting state waiting an order of its printing avoiding the intervals of sleep mode. That is, that print job is handled as a print job put in a waiting state after reception.

At a step S3, a timer incorporated in the controller 13 of the image forming machine 10 arrives at a prescribed time close to a time of day preset in the scheduled run by the managing person, that is, 12:00 a.m. or 3:00 p.m. This arrival event is detected as an event requiring a transition into a nearest sleep mode in the scheduled run.

The detection of the event above is followed by a step S4, in which it is determined whether or not any print job having been already received till then is being printed. If a received print job is determined as being printed, the control flow goes to a step S5. At the step S5, the controller 13 interrupts the printing of that print job. Then, the controller 13 identifies an unprinted remaining part or entirety of the print job overlapping a prescribed interval of the nearest sleep mode, as an associated hold job, and stores the hold job in a hold job storage area 162 of the memory 16.

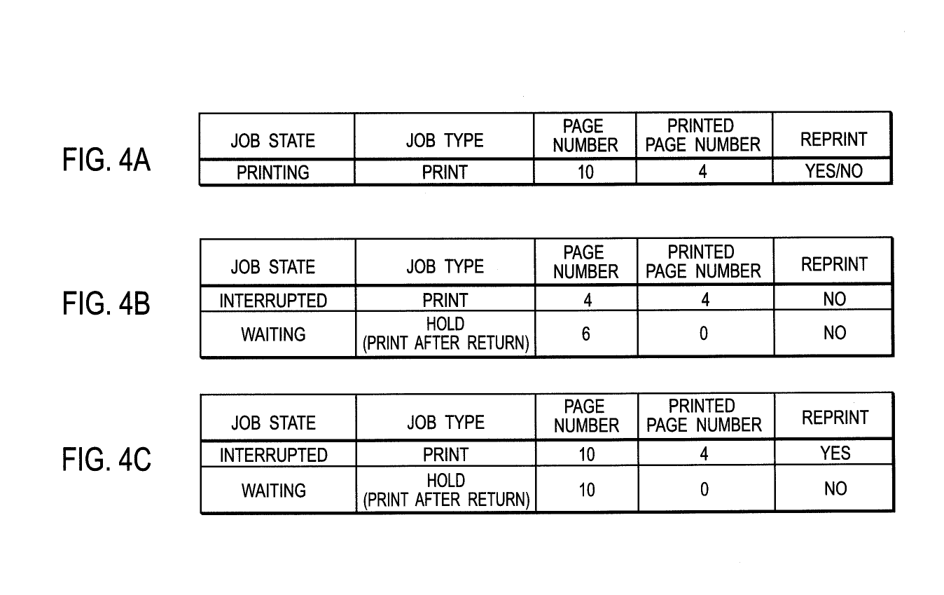

FIG. 4A shows pieces of information on a print job being printed when having arrived at a time of day preset for a sleep mode. The pieces of information are given as data on attributes of the print job including a job state, a job type, a total page number (as the number of pages to be printed), a printed page number, and a duty of reprint (in terms of the necessity). In FIG. 4A, the job state is “printing”. The job type is “print”. The total page number is “ten”. The printed page number is “four”. The duty of reprint is “YES (present)” or “NO (absent)”. FIG. 4B, as well as FIG. 4C, shows a combination of data on attributes of an interrupted print job and data on attributes of an associated hold job. In either case, there is an original print job being printed when having arrived at a time of day preset for a sleep mode. And, an entirety or printed part of the original print job is identified as the interrupted print job. The associated hold job is determined in conjunction with, or irrespective of, the progress of printing of the original print job. In the case of FIG. 4B, the duty of reprint of the original print job is “NO”. Accordingly, the hold job is identified as a new print job corresponding to the absence of the necessity of reprint. In the case of FIG. 4C, the duty of reprint of the original print job is “YES”. Accordingly, the hold job is identified as a new print job corresponding to the presence of the necessity of reprint.

In FIG. 4B, no reprint is required for the original print job. In this case, when having arrived at a time of day preset for a sleep mode, the original print job has a printed part thereof identified as an interrupted print job. The interrupted print job has data on attributes thereof, as follows. The job state is “interrupted”. The job type is “print”. The total page number is “four”. The printed page number is “four”. The duty of reprint is “NO”. In the case the duty of reprint of an original print job is “NO”, if any part of the original print job has already been printed, that part of this print job will not be reprinted. The hold job then identified has data on attributes thereof, as follows. The job state is “waiting”. The job type is “hold (for a print after return)”. The total page number is “six”. The printed page number is “zero”. The duty of reprint is “NO”. In other words, the original print job is divided when the state of power distribution transitions into the sleep mode. The hold job is identified as a divided part of the original print job that overlaps a prescribed interval of the sleep mode. The hold job has a set of data thereon including the attribute data and print data, which is stored in a hold job storage area 162. That is, the divided part of the original print job overlapping the interval of the sleep mode is stored in the hold job storage area 162. The original print job has a part thereof having been printed until it arrives at the time of day preset for the sleep mode. This part of the original print job is not stored in any hold job storage area 162. Therefore, the hold job storage areas 162 can have a reduced total storage capacity. The duty of reprint of the hold job is “NO”. Therefore, once the hold job is printed, the hold job will not be reprinted

In FIG. 4C, a reprint is required for the original print job. In this case, when having arrived at a time of day preset for a sleep mode, the original print job has an entirety thereof identified as an interrupted print job. The interrupted print job has data on attributes thereof, as follows. The job state is “interrupted”. The job type is “print”. The total page number is “ten”. The printed page number is “four”. The duty of reprint is “YES”. In the case the duty of reprint of an original print job is “YES”, even if any part of the original print job has already been printed, an entirety of this print job will be reprinted. The hold job then identified has data on attributes thereof, as follows. The job state is “waiting”. The job type is “hold (for a print after return)”. The total page number is “ten”. The printed page number is “zero”. The duty of reprint is “NO”. Since the duty of reprint of the hold job is “NO”, once the hold job is printed, the hold job will not be reprinted. The original print job is not divided when the state of power distribution transitions into the sleep mode. This print job is identified as it is as a hold job, which is stored in a hold job storage area 162.

It is noted that, at the step S5, if any print job is found as having been put in a waiting state after reception, the controller 13 may handle this print job like a print job “being printed” after reception, to identify its entirety (e.g. 10 pages) as a hold job. In this case, the print job assumed as if its printing were interrupted has data on attributes thereof, as follows. The job state is “interrupted”. The job type is “print”. The total page number is “ten”. The printed page number is “zero”. The duty of reprint is “YES”. The hold job then identified has data on attributes thereof, as follows. The job state is “waiting”. The job type is “hold (for a print after return)”. The total page number is “ten”. The printed page number is “zero”. The duty of reprint is “NO”.

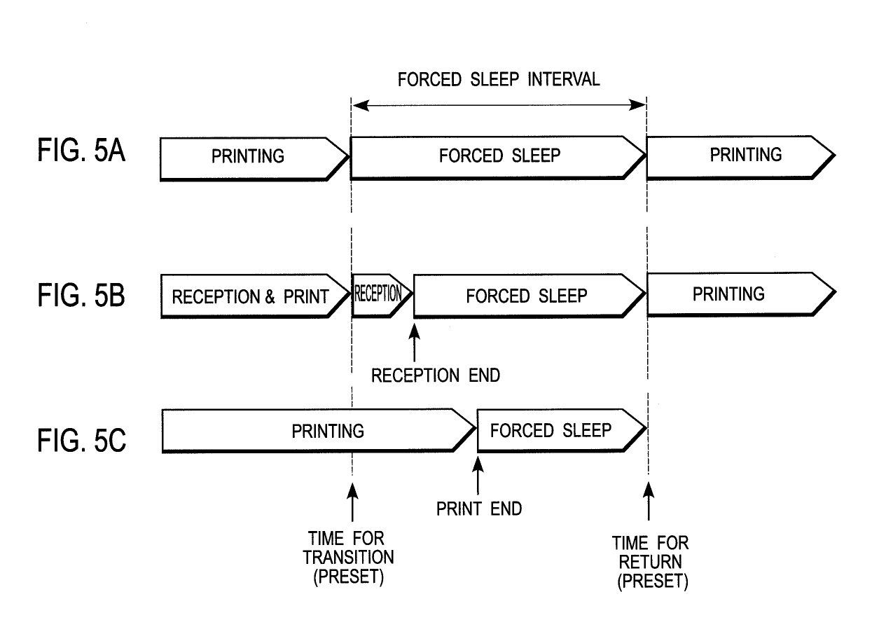

FIG. 5A is a time chart illustrating an interval of a sleep mode together with a previous and a subsequent mode of control in a scheduled run of the image forming machine 10. FIG. 5C is a time chart illustrating a comparable example. As shown in FIG. 5A, the image forming machine 10 can promptly transition into the sleep mode at a time of day preset in the scheduled run, in comparison with the case of FIG. 5C. This ensures that the sleep mode is continued over the preset interval, allowing for a significant decrease in consumption of power.

The above-described step S5 is followed by a step S6. At this step, it is determined whether or not any print job is being received at the I/O port 12. The control flow comes to this step also when it is determined at the step S4 that no print job is being printed. If it is determined at the step S6 that a print job is being received, the control flow goes to a step S7. At the step S7, it is determined whether or not the receiving print job is being printed. If this print job is determined as being printed, the control flow goes to a step 8. At the step S8, the controller 13 operates to interrupt the printing of the receiving print job, while leaving this print job as it is received to an end. The receiving print job thus has a page-increasing part overlapping the interval of the current sleep mode. The controller 13 further operates to identify the page-increasing part of the receiving print job, as a hold job.

The step S8 is followed by a step S9. At this step, it is determined whether or not the reception of the receiving print job is completed with all pages received. The control flow comes to this step also when it is determined at the step S7 that the receiving print job is not being printed. If it is determined at the step S9 that the reception of the receiving print job has not completed yet, this step S9 is repeated until the reception gets completed. The hold job identified as a page-increasing part of the receiving print job has a set of varying data thereon including attribute data and print data, which is stored and updated in a hold job storage area 162 from time to time.

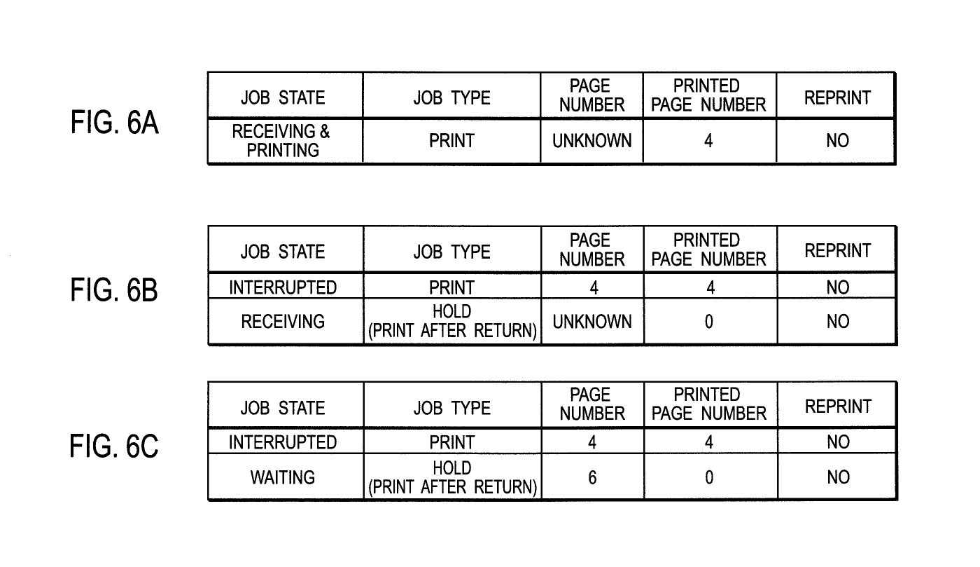

FIG. 6A shows pieces of information on a print job being received when having arrived at the time of day preset for the nearest sleep mode. The pieces of information are given as data on attributes of the print job including a job state, a job type, a total page number, a printed page number, and a duty of reprint. In FIG. 6A, the job state is “receiving & printing”. The job type is “print”. The total page number is “unknown”. The printed page number is “four”. The duty of reprint is “NO”.

FIG. 6B shows a combination of data on attributes of an interrupted print job and data on attributes of an associated hold job. There is a receiving print job being printed when having arrived at the time of day preset for the nearest sleep mode. The receiving print job has a part thereof having been printed till then, which is identified as the interrupted print job. The associated hold job is determined in conjunction with the progress of printing of the receiving print job. Upon the arrived at the time of day preset for the nearest sleep mode, the interrupted print job has data on attributes thereof, as follows. The job state is “interrupted”. The job type is “print”. The total page number is “four”. The printed page number is “four”. The duty of reprint is “NO”. The hold job then identified has data on attributes thereof, as follows. The job state is “receiving”. The job type is “hold (for a print after return)”. The total page number is currently “unknown”. The printed page number is “zero”. The duty of reprint is “NO”.

FIG. 6C shows a combination of data on attributes of an interrupted print job and data on attributes of an associated hold job. The above-noted receiving print job has a defined total page number when its reception is completed with all 10 pages received. This print job has a printed part identical to that of FIG. 6B, and the remaining part. The printed part is identified as the interrupted print job. The remaining part is identified as the associated hold job. The interrupted print job has data on attributes thereof, as follows. The job state is “interrupted”. The job type is “print”. The total page number is “four”. The printed page number is “four”. The duty of reprint is “NO”. The hold job then identified has data on attributes thereof, as follows. The job state is “waiting”. The job type is “hold (for a print after return)”. The total page number is “six”. The printed page number is “zero”. The duty of reprint is “NO”.

If the duty of reprint of the interrupted print job is “YES”, an entirety of the print job defined when the reception is completed is not divided, and is identified as it is as a hold job.

FIG. 5B is a time chart illustrating an interval of a sleep mode together with a previous and a subsequent mode of control in a scheduled run of the image forming machine 10. As shown in FIG. 5B, the image forming machine 10 cannot transition into the sleep mode from a time of day preset in the scheduled run, till the reception of a print job ends with all pages received. As a result, the sleep mode has a somewhat shortened interval in comparison with the case of FIG. 5A. However, this interval of time is not so long as needed to complete a printing of the print job as illustrated in FIG. 5C, but as short as taken to complete the reception of the print job being electronic data. Therefore, the state of power distribution can smoothly transition into the sleep mode near the preset time of day. This ensures that the sleep mode is substantially continued over the preset interval, allowing for a significant decrease in consumption of power.

The before-mentioned reception of the print job is completed with all paged received at the step S9, which is followed by a step S10, where the image forming machine 10 transitions into the nearest sleep mode. Then, at a step S11, this sleep mode makes progress as a current sleep mode.

(2) Method of Returning from a Sleep Mode

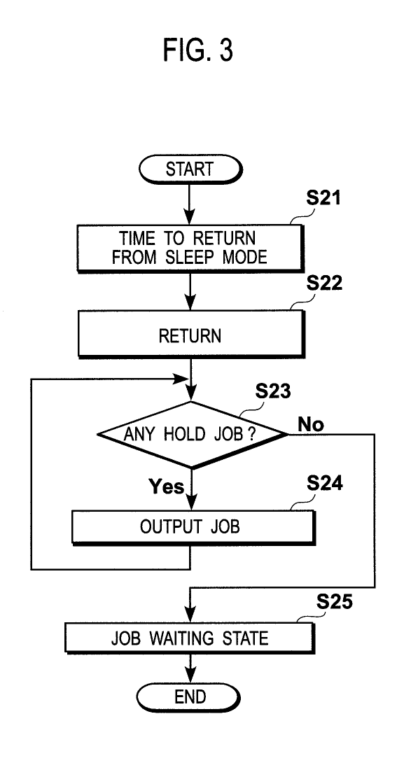

FIG. 3 shows a method of returning from a sleep mode in a scheduled run of the image forming machine 10 according to the first embodiment.

At a step S21, a timer incorporated in the controller 13 of the image forming machine 10 arrives at a prescribed time close to a time of day preset in the scheduled run by the managing person, that is, 1:00 p.m. or 3:30 p.m. This arrival event is detected as an event requiring a return from the current sleep mode.

The detection of the event above is followed by a step S22, in which the image forming machine 10 returns from the current sleep mode, to transition into one of the low power mode and the ready mode, that is, to enter an active state. Then, at a step S23, the controller 13 operates to determine whether or not any hold job that has been identified upon the transition into the previous sleep mode is still present.

If any hold job is present, the control flow goes to a step S24. At this step, the controller 13 reads the hold job from a hold job storage area 162 of the memory 16, to output to the mapper 17. The mapper 17 maps the hold job into print data, and outputs the print data to the printer 18. The printer 18 makes a print on a recording medium in accordance with the print data. The step S24 is repeated to print any and all hold jobs stored in hold job storage areas 162 of the memory 16.

After any and all hold jobs are output, the control flow goes to a step S25. At this step, the image forming machine 10 makes a transition into the low power mode or the ready mode, to enter a job waiting state.

### Features of the First Embodiment

As will be seen from the foregoing description, according to the first embodiment, an image forming machine 10 is adapted to store in a memory a hold job identified as an entirety or part of a print job overlapping an interval of a sleep mode. The image forming machine 10 is adapted to print the hold job after lapse of the interval of the sleep mode. Accordingly, it is ensued that the state of power distribution transitions into the sleep mode at a preset time of day, and resides there over a prescribed interval. This allows for an ensured reduction in consumption of power during the interval.

Moreover, according to the first embodiment, the image forming machine 10 is adapted, upon detection of an event requiring a transition into the sleep mode, to determine a part of the print job overlapping the interval of the sleep mode. The image forming machine 10 is adapted to identify the part of the print job overlapping the interval of the sleep mode as a hold job, and to store the hold job in a hold job storage area 162 of a memory 16. It therefore is avoidable to store in the memory 16 any part of the print job that has already been printed. That is, the memory 16 is not required to store therein any part of the print job that has already been printed and useless for a subsequent printing. Accordingly, the image forming machine 10 is allowed to have decreased power consumption. The memory 16 is permitted to have a reduced storage capacity. The image forming machine 10 can thus be minimized in size.

Further, according to the first embodiment, the image forming machine 10 is adapted to print a hold job stored in the memory 16, excluding such job part that has already been printed. Therefore, redundant prints can be eliminated, allowing for still reduced power consumption. Waste of recording medium can also be eliminated.

### Second Embodiment

The second embodiment of the present invention is described as an example of the image forming machine 10 according to the first embodiment, including a hold job having an increased security on a print output (as a print product) thereof. In the image forming machine 10 according to the first embodiment, any hold job has been automatically read to print after lapse of an interval of a sleep mode. Such a print output might be seen by a third person, when the user was unable to go for the print output immediately after lapse of the interval of the sleep mode. According to the second embodiment, an image forming machine 10 is adapted to avoid such an issue.

[Control Methods of Image Forming Machine]

(1) Method of Transitioning into a Sleep Mode

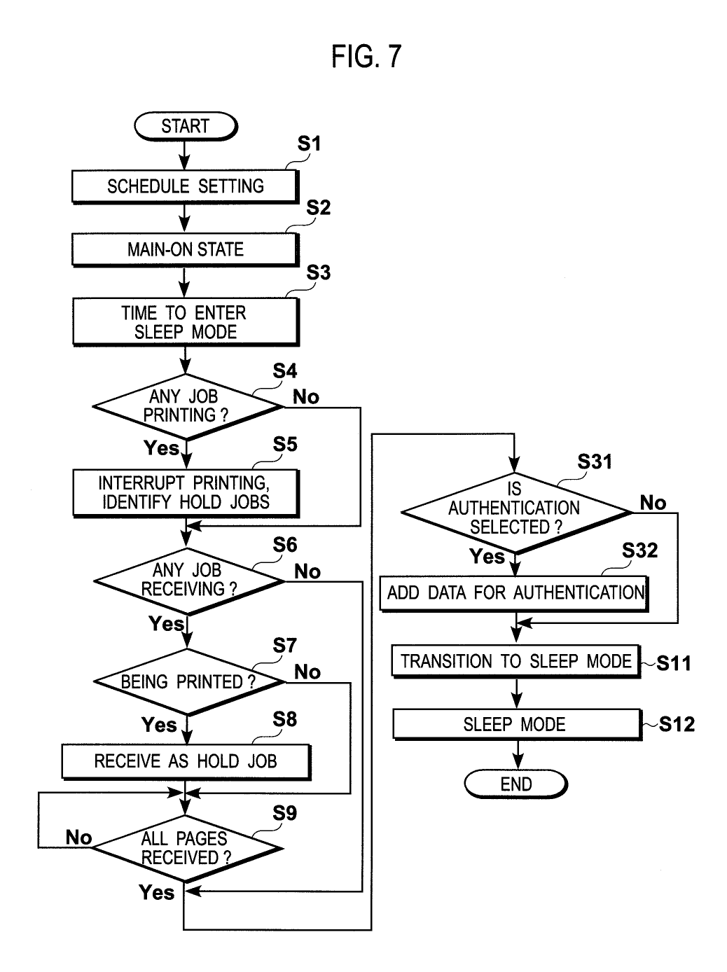

FIG. 7 shows a method of transitioning into a sleep mode in a scheduled run of the image forming machine 10 according to the second embodiment. This method is essentially similar to the method of transitioning into a sleep mode in a scheduled run of the image forming machine 10 according to the first embodiment. According to the second embodiment, the method of transitioning into a sleep mode has additional steps S31 and S32 after a step S9. At the step S31, it is determined whether or not an identified hold job is conditioned to change into a hold job that requires an authentication. If the hold job is conditioned to change into a hold job requiring an authentication, the control flow goes to the step S32 at which an authentication data adding process is executed to the hold job, as will be described later on.

In the second embodiment, each hold job that a controller 13 of the image forming machine 10 has determined as requiring an authentication has, or is conditioned to have, an authentication data added thereto as necessary for an output to print at a time intended by the user. The addition of authentication data constitutes a bar to prohibit the hold job from being automatically output to print after a return from the sleep mode. That is, the hold job is kept stored in a hold job storage area 162 of a memory 16 in the image forming machine 10. It is prohibited for any user to access the hold job (e.g. to output to print), unless the user is authenticated by the image forming machine 10. On the other hand, each hold job the controller 13 has determined as requiring no authentication does not have, or is not conditioned to have, any effective authentication data. For instance, for a hold job, the user may decide that it should not be changed into any authentication requiring hold job. In this case, the hold job will be automatically output to print as a hold job requiring no authentication after a return from the sleep mode. The image forming machine 10 may receive a print job with an authentication data already added thereto. The received print job may be accompanied by a request from the user (who may be to go outside just before a lunch break) to change the print job into an authentication requiring hold job. The request may be separately transmitted before detection of an even requiring a transition into a sleep mode. In such a case, the controller 13 handles the print job like a print job “being printed” (up to a 0 page) to identify as a hold job, and changes the hold job into an authentication requiring hold job. The authentication data is inherited as it is in the hold job, and in the authentication requiring hold job.

At the step S9, the controller 13 has completed each process of identifying an entirety of a (re-printable) print job or an imprinted part of a print job (unable to reprint), as a hold job. This processing is made for each print job having had a “real” reception time and/or print time determined as will be overlapping at least part of an interval of a nearest sleep mode. In this respect, each print job targeted was “being received” without printing, “being received” while “being printed”, or “being printed” after reception, substantially when an event requiring a transition into the sleep mode was detected. Each print job is given a print job ID, and stored in a print job storage area 161. The print job ID is associated with an ID of an originator of the print job. Each hold job is given a hold job ID, and stored in a hold job storage area 162. The hold job ID is associated with a print job ID of an original print job.

The step S9 is followed by the step S31. At this step, the image forming machine 10 sends a message on any print job identified as a hold job, to an external terminal 20 (as a user) having transmitted the print job to the image forming machine 10. The message includes a notice that an entirety or part of the print job has been determined as overlapping an interval of a sleep mode, and identified as a hold job to be automatically printed after lapse of the interval. The message lists data on attributes of the hold job. If the hold job is determined as a hold job requiring no authentication, the above message further includes an interrogation that asks if the external terminal 20 (as the user) wants to request changing the hold job into an authentication requiring hold job. When given a reply from the external terminal 20 requesting the change, the controller 13 determines that the hold job is conditioned to change into an authentication requiring hold job. Then, at the step S32, the controller 13 executes an authentication data adding process for each hold job conditioned to change into an authentication requiring hold job. The authentication data adding process includes acquiring authentication data (e.g. password) in communication with an external terminal 20 as an originator of an original print job of the hold job, and adding the authentication data to the hold job. This process further includes labeling the hold job as an authentication requiring hold job.

It is noted that at a step S4 or at a step S6 or S7 in the flowchart of FIG. 7, the controller 13 may predict an occurrence of hold job based on a relation between a time of day preset to transition into a sleep mode and a volume of a print job being received or being printed. When a hold job is predicted, the controller 13 may acquire its ID.

The image forming machine 10 may acquire authentication data (e.g. password) in communication with an external terminal 20 at the step S31 in place of the step S32.

In the second embodiment, the authentication data adding process at the step S32 is followed by steps S11 and S12, which are executed like those in the first embodiment.

(2) Method of Returning from a Sleep Mode

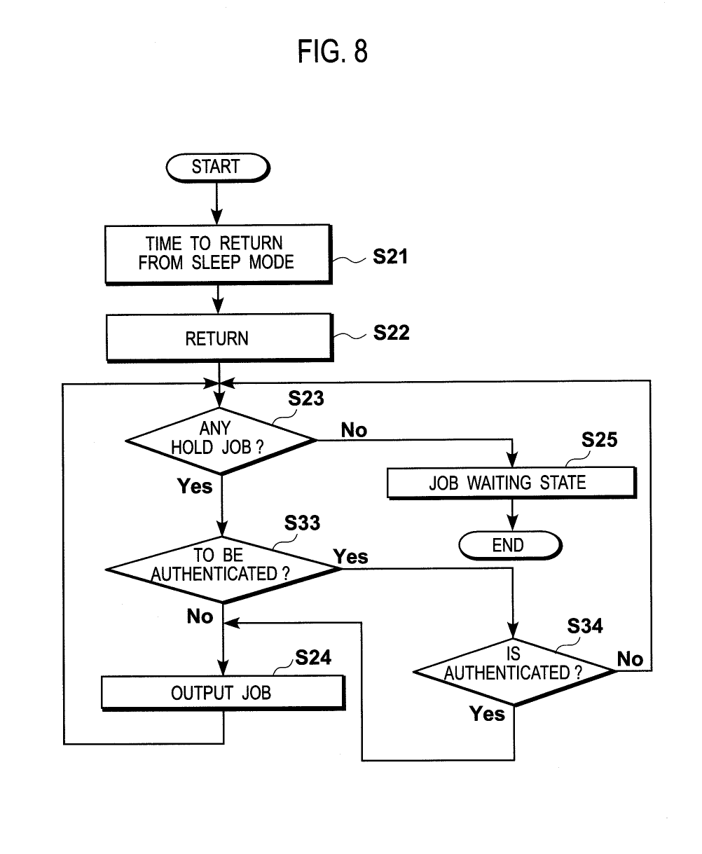

FIG. 8 shows a method of returning from a sleep mode in a scheduled run of the image forming machine 10 according to the second embodiment This method is essentially similar to the method of returning from a sleep mode in the image forming machine 10 according to the first embodiment According to the second embodiment, the method of returning from a sleep mode has additional steps S33 and S34. At the step S33, it is determined whether or not an identified hold job requires an authentication. At the step S34, it is determined whether or not an originator of an original print job has completed the authentication.

According to the second embodiment, at a step S22 in FIG. 8, a return from a sleep mode is followed by a delivery of a return notice to external terminals 20. After that, at the step S23, if any hold job is found in a hold job storage area 162, the control flow goes to the step S33. At this step, the hold job is checked if it requires an authentication. If the hold job requires no authentication, the control flow goes from the step S33 to a step S24 to print the hold job. If the hold job requires an authentication, the control flow goes from the step S33 to the step S34 to check if the authentication is completed. If the authentication is completed, the control flow goes from the step S34 to the step S24 affording to print the hold job at a desirable time. Unless the authentication is completed, the control flow goes from the step S34 again to the step S23. At this step, if no stored hold job is found yet, the control flow goes to a step S25 to enter a job waiting state. It is noted that there is an authentication method employed for hold jobs, which is the same as a standard authentication method employed for normal print jobs overlapping no sleep modes.

After a determination at the step S33 that a hold job requires an authentication or after a determination at the step S34 that a required authentication is not completed, the image forming machine 10 may operate as follows. The image forming machine 10 may then prompt a corresponding external terminal 20 (user) to complete the authentication to execute a printing, by sending a prescribed form. In this case, the external terminal 20 can execute the printing from its place, by inputting an authentication data (e.g. password) and a printing instruction (e.g. ‘print’) to the form, and returning the form to the image forming machine 10 at a desirable time.

In the second embodiment, the image forming machine 10 performs an authentication for an authentication requiring hold job in communication with an external terminal 20. The image forming machine 10 may use a non-depicted touch panel on a panel 11 to make an authentication. In this case, for the authentication, the user can input an authentication data (e.g. password) from the touch panel. In the second embodiment, the controller 13 leaves it at a user's decision to determine whether or not an identified hold job should be changed into an authentication requiring hold job. The controller 13 may change each identified hold job into an authentication requiring hold job, to execute its printing after completion of an authentication therefor.

### Features of the Second Embodiment

According to the second embodiment, an image forming machine 10 is adapted to change an identified hold job into an authentication requiring hold job, to execute its printing subject to an authentication. Accordingly, a resultant print (on a printing medium) is free from anxieties about being seen by a third person after lapse of an interval of a sleep mode, allowing for an increased security.

### Third Embodiment

The third embodiment of the present invention is described as an example of the image forming machine 10 according to the first embodiment, in which an urgent temporary printing is performed during a sleep mode. The image forming machine 10 according to the first embodiment has been essentially prohibited to execute any printing during any sleep mode. According to the third embodiment, an image forming machine 10 is adapted to execute an urgent printing during a sleep mode as a modified case.

[Control Method of Image Forming Machine]

Method of Returning from a Progressing Sleep Mode

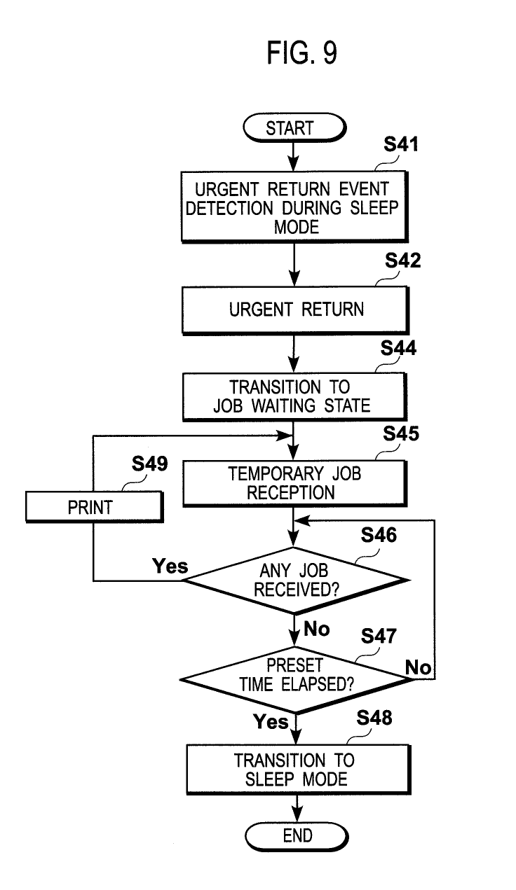

FIG. 9 shows a method of returning from a sleep mode in a forced manner during a prescribed interval of the sleep mode in a scheduled run in the image forming machine 10 according to the third embodiment.

During an interval of a sleep mode there may be a print job transmitted with information appealing the need of an urgent printing from an external terminal 20 to the image forming machine 10. At a step S41 in FIG. 9, a print job that carries information appealing the need of an urgent printing is received at the image forming machine 10, where the information appealing the need of an urgent printing is detected. The information appealing the need of an urgent printing is detected as information added to a field of PDL (page description language) in the print job that was prepared by a printer driver of an external terminal 20. In the image forming machine 10, a controller 13 detects the affair at the step S41 as an event requiring a forced return from a current sleep mode during a prescribed interval of the sleep mode. This event detection is followed by a step S42. At this step, the image forming machine 10 executes a forced return process of returning from the current sleep mode to transition into an active state in a low power mode or a ready mode.

As a result, at a step S44, the image forming machine 10 is shifted into a job waiting state for receiving any print job needing an urgent printing. That is, at a step S45, this state is retained for a prescribed time, in which any print job needing an urgent printing is received. The prescribed time is an interval for receiving print jobs, and is measured by using e.g. a timer incorporated in the controller 13. Essentially, the prescribed time is set to be shorter than the interval of the current sleep mode. At a step S46, the image forming machine 10 checks for reception of a print job needing an urgent printing. If any print job needing an urgent printing is received, the control flow goes to a step S49, where the print job is printed.

If no print job needing an urgent printing is received, the control flow goes to a step S47, where the prescribed time is checked. If the prescribed time is elapsed, the image forming machine 10 stops receiving a print job needing an urgent printing. Then, the control flow goes to a step S48, where the image forming machine 10 again transitions into the current sleep mode. As a result, this control method goes to an end.

In the control method for the image forming machine 10 according to the third embodiment, the step S48 of FIG. 9 may be substituted by e.g. the steps S11 and S12 of FIG. 2 in the control method of returning from a sleep mode according to the first embodiment

### Features of the Third Embodiment

According to the third embodiment, an image forming machine 10 is adapted to cope even with a print job needing an urgent printing, while allowing for reduced power consumption along with transition to and continuation of a sleep mode.

It is noted that the control method for the image forming machine 10 according to the third embodiment is applicable also to the image forming machine 10 according to the second embodiment

### Other Embodiments

Although the present invention has been described by using the first to third embodiments, those drawings and discussions constituting part of the disclosure should not be construed as being restrictive to the present invention. The present invention is applicable to various substitute embodiments, embodiment examples, and techniques for use. For instance, the present invention is not simply applicable to printing operations based on print jobs of the image forming apparatuses described, but also applicable to operations of the scanner 151 and the facsimile 152. The scanner 151 and the facsimile 152 are adapted for actions to take in image frames as well as for their printing, which are covered by the function of sleep mode.

The present invention allows for an ensured implementation of a prescribed interval of sleep mode starting at a preset time of day, and has widespread applications to image forming apparatuses adapted for reduction of power consumption.

The present application claims the benefit of priority under 35U.S.C.§119 to Japanese Patent Application No. 2010-293876, filed on Dec. 28, 2010, the entire content of which is incorporated herein by reference.

What is claimed is:

1. An image forming apparatus adapted to transition into a sleep mode at a preset time of day and to keep the sleep mode for a prescribed interval, the image forming apparatus comprising:
an input interface configured to input a print job;
a printer configured to execute a printing of the print job;
a memory configured to store therein an entirety or part of the print job overlapping the interval of the sleep mode, as a hold job; and
a controller configured to have the memory store the hold job therein, and to have the printer operate after an end of the interval of the sleep mode to execute a printing of the hold job stored in the memory.

2. The image forming apparatus according to claim 1, wherein the controller is operable in response to a detection of an event for a transition into the sleep mode, to determine whether or not the print job has any part thereof overlapping the interval of the sleep mode, and when the print job has a part thereof overlapping the interval of the sleep mode, to have the memory store therein the part overlapping the interval of the sleep mode, as the hold job.

3. The image forming apparatus according to claim 2, wherein the controller is operable to have the printer print the hold job stored in the memory as being the part of the print job overlapping the interval of the sleep mode.

4. The image forming apparatus according to claim 2, wherein the controller is operable when the hold job is a hold job requiring no authentication, to change the hold job requiring no authentication into an authentication requiring hold job, and to have the printer print the authentication requiring hold job subject to an authentication therefor.

5. The image forming apparatus according to claim 2, wherein the controller is operable in response to a detection of an event requiring an urgent return within the interval of the sleep mode, to transition into a ready mode of a prescribed time, and when a print job requiring an urgent printing is input to the input interface within the prescribed time, to have the printer execute a printing of the print job requiring an urgent printing.
